(19) United States
(12) Patent Application Publication
(10) Pub. No.: US 2026/0186768 A1
(43) Pub. Date: Jul. 2, 2026

(54) EMBEDDED DEVICE FIRMWARE UPDATING METHOD, EMBEDDED DEVICE, AND DEVELOPMENT END DEVICE

(71) Applicant: ESPRESSIF SYSTEMS (SHANGHAI) CO., LTD., Shanghai (CN)

(72) Inventor: Yuxin WANG, Shanghai (CN)

(21) Appl. No.: 18/864,596

(22) PCT Filed: Apr. 21, 2023
(86) PCT No.: PCT/CN2023/089852

§ 371 Date: Nov. 11, 2024

(30) Foreign Application Priority Data
May 18, 2022 (CN) 202210548038.7

(51) Int. Cl. G06F 8/658

(52) U.S. Cl. CPC G06F 8/658

(57) ABSTRACT

Disclosed in the present application are a firmware update method for an embedded device, an embedded device, a development end device, and a firmware update system for an embedded device. The embedded device acquires patch data from a source device and decompress the patch data to obtain original differential coding data; acquires data blocks in the original differential coding data in batches, and respectively perform corresponding operations on the data blocks according to a state identifier configured to indicate the currently performed operation, until differential decoding of the original differential coding data is accomplished.

### CROSS-REFERENCE TO RELATED APPLICATIONS

This application is the U.S. National Phase Application under 35 U.S.C. § 371 of International Patent Application No. PCT/CN2023/089852 filed on Apr. 21, 2023, which claims priority to CN Patent Application 202210548038.7 filed on May 18, 2022. The disclosures of the aforementioned applications are hereby incorporated by reference in their entireties.

### TECHNICAL FIELD

The present application relates to the field of embedded technology, and in particular to a firmware update method for an embedded device, an embedded device, a development end device, and a firmware update system for an embedded device.

### BACKGROUND

The rapid development of Internet of Things (IoT) technology has facilitated the large-scale use of low-cost embedded devices which are widely deployed in application scenarios such as smart homes, smart industries, and healthcare to accomplish functions such as intelligent perception, intelligent control, and intelligent networking. In embedded devices, firmware is usually stored on non-volatile storage devices such as Flash, SD cards, and solid-state drives, and after the device is booted up, the stored firmware is loaded into a RAM memory to perform specified functions. Firmware defines the primary functionality of a product. Device manufacturers often utilize FOTA (Firmware Over the Air) remote firmware update technology to rapidly iterate on device software to meet market demands for product functionality, improve user experience, and remotely fix security vulnerabilities in the firmware.

One of the basic conditions for implementing firmware update is to transmit the updated firmware data to the device to be updated. Firmware updates can be categorized as follows based on how the transmitted updated firmware data is processed:
(1) Full update: this firmware update method directly sends the updated firmware generated by compiling to the device to be upgraded;
(2) Compression update: this firmware update method compresses the updated firmware data generated by compiling through a compression algorithm, and then sends the compressed data to the device to be upgraded;
(3) Incremental update (also known as differential update): as shown in FIG. 1, this firmware update method can be divided into two processes: generating patch data and applying patch data. On the development end device, the patch data is obtained by differentiating between the updated firmware data and the old firmware data. On the embedded device, the patch data is received and combined with the old firmware data to restore the updated firmware data.

Among the above methods, the firmware update method of incremental update is more suitable for usage scenarios where the updated firmware data is less altered than the old firmware data. When the difference between the updated firmware data and the old firmware data is small, such as in the case of only some system parameters are changed or a small piece of code is inserted, compared with the full update and compression update, the firmware update method of incremental update needs to transmit only the difference information between the updated firmware data and the old firmware data. Therefore, the amount of data that needs to be transmitted is small, which can save the traffic of firmware updates, improve the success rate of updates, and ensure the stability of IoT systems.

However, since IoT systems are typically composed of a series of devices with different software and hardware resources, the available memory size is inconsistent among different devices, making it difficult to deploy the same incremental update solution for use on devices with different resources. On the other hand, the current method of performing firmware updates using an incremental update method requires a large amount of memory consumption, thus rendering the incremental update method incapable of being run in resource-constrained IoT devices.

Therefore, how to design an incremental update solution with flexible configuration of resource consumption, good extensibility, and the ability to be run in resource-constrained IoT devices is one of the technical problems to be solved urgently in the art.

It is appreciated that the technical problems listed above are only examples and not limitations of the present application, and the present application is not limited to technical solutions that solve all of the above technical problems at the same time. The technical solution of the present application can be implemented to solve one or more of the above or other technical problems.

### SUMMARY OF THE INVENTION

To solve the above and other problems, the present application provides a firmware update method for an embedded device, which is applied to the embedded device, and the method includes:
acquiring patch data from a source device, the patch data being data obtained by compressing original differential coding data, and the patch data being a part of data in a patch file;
decompressing the patch data to obtain the original differential coding data, the original differential coding data being data obtained after performing differential processing and encoding on old firmware data and updated firmware data, and the original differential coding data including a plurality of data blocks, wherein each of the plurality of data blocks includes control data, difference data, and extra data;
acquiring data blocks in the original differential coding data in batches, and performing corresponding operations on the data blocks respectively according to a state identifier configured to indicate the currently performed operation, until differential decoding of the original differential coding data is accomplished.

Optionally, the performing corresponding operations on the data blocks respectively according to a state identifier configured to indicate the currently performed operation includes:
in response to that the state identifier is a first identifier indicating the performing of an operation to read the control data, reading the control data;
in response to that the state identifier is a second identifier indicating the performing of an operation to add the difference data, reading, according to the control data, the difference data into a pre-allocated buffer in batches to perform an addition operation, wherein a length of the data for a single addition operation does not exceed a preset buffer length;
in response to that the state identifier is a third identifier indicating the performing of an operation to copy the extra data, reading, according to the control data, the extra data into the buffer in batches to perform a copy operation, wherein a length of the data for a single copy operation does not exceed the preset buffer length;
wherein the data obtained after performing the addition operation or the copy operation is written into a storage partition of the embedded device.

Optionally, the patch file further includes file header information, and after the acquiring patch data from a source device, the method further includes:
reading the file header information from the patch file;
in response to that the state identifier is a fourth identifier indicating the performing of verification of the file header information, verifying the file header information according to the file header information;
in response to that the verification passes, modifying the state identifier from the fourth identifier to the first identifier.

Optionally, after the reading the control data, the method further includes:
modifying the state identifier from the first identifier to the second identifier after reading a complete control data.

Optionally, after the reading, according to the control data, the difference data into a pre-allocated buffer in batches to perform an addition operation, the method further includes:
determining, based on the number of bytes of difference data in the data block indicated in the control data, whether the addition operation for the data block is accomplished;
if yes, modifying the state identifier from the second identifier to the third identifier.

Optionally, after the reading, according to the control data, the extra data into the buffer in batches to perform a copy operation, the method further includes:
determining, based on the number of bytes of extra data in the data block indicated in the control data, whether the copy operation for the data block is accomplished;

If yes, modifying the state identifier from the third identifier to the first identifier.

Optionally, the preset buffer length is adjustable according to actual memory of the embedded device.

Optionally, the preset buffer length is stored in file header information of the patch file.

Optionally, the state identifier is indicated by a state machine provided.

Optionally, the decompressing the patch data includes:
decompressing the patch data using a decompression algorithm supporting streaming decompression.

The present application further provides an embedded device including: a first memory and a first processor, the first memory is configured to store a computer program, and the first processor is configured to implement any of the above firmware update method for an embedded device when executing the computer program.

The present application further provides a firmware update method for an embedded device, which is applied to a development end device, and the method includes:
determining similarity matching regions of old firmware data and updated firmware data, performing differential processing on data in the similarity matching regions and encoding as difference data;
encoding the data between two similarity matching regions as extra data;
generating control data based on the difference data and the extra data;
writing the generated control data, the difference data, and the extra data into a data block, and arranging a plurality of data blocks to obtain original differential coding data;
compressing the original differential coding data to generate patch data for firmware update of the embedded device, the patch data being a part of data in the patch file.

Optionally, after the generating patch data for firmware update of the embedded device, the method further includes:
packing the patch data to generate a patch file;
sending the patch file to a source device for storage, for the embedded device to acquire the patch data in the patch file from the source device.

Optionally, the patch file further includes file header information, the file header information includes a decompression algorithm to be used by the embedded device, a decompression level, verification information for verification, and a preset buffer length.

The present application further provides a development end device including: a second memory and a second processor, the second memory is configured to store a computer program, and the second processor is configured to implement any of the above firmware update method for an embedded device when executing the computer program.

The present application further provides a firmware update system for an embedded device including the embedded device described above and a source device; the source device stores a patch file for firmware update of the embedded device, the patch data is a part of data in the patch file, and the patch data is data obtained by compressing original differential coding data.

Optionally, the source device is a development end device or a cloud device or other devices in the network where the embedded device is located.

For the firmware update method for an embedded device provided in the present application, the embedded device acquires patch data from a source device, decompresses the patch data, and obtains original differential coding data, the original differential coding data is data obtained after performing differential processing and encoding on old firmware data and updated firmware data, and the original differential coding data includes a plurality of data blocks, wherein each of the plurality of data blocks includes control data, difference data, and extra data; data blocks in the original differential coding data are acquired in batches, and corresponding operations are respectively performed on the data blocks according to a state identifier configured to indicate the currently performed operation, until differential decoding of the original differential coding data is accomplished.

The solution provided in the present application may acquire only a part of the data of the patch file during the firmware update of the embedded device, instead of directly acquiring the complete patch file, avoiding excessive storage pressure on the device caused by the large amount of data that needs to be temporarily stored to obtain the patch file. The data may be acquired in batches and the acquired data may be processed in batches in a timely manner. By acquiring data blocks in the original differential coding data in batches, and using a state identifier to indicate the currently performed operation, corresponding operations may be performed on the control data, difference data, and extra data in each data block, and differential decoding may be performed in batches. The data obtained after differential decoding may be written into a specified storage partition in a timely manner without the need to perform operation after obtaining the complete data block, avoiding consumption of device memory caused by temporarily storing too much data in the memory, enabling the incremental update method also to be run normally on IoT devices with limited resources such as small memory.

Furthermore, the memory consumption in the incremental update solution provided in the present application may be flexibly controlled, such that the incremental update solution can not only be run on devices with large memory resources, but also be implemented on devices with smaller memory resources by setting the value of the buffer. In addition, the present application solution may also be used in combination with various algorithms supporting streaming decompression, with better extensibility.

In addition, the present application further provides an embedded device, a development end device, and a firmware update system for an embedded device having the above technical advantages.

### BRIEF DESCRIPTION OF THE DRAWINGS

The present application will be further explained hereinafter based on embodiments with reference to the accompanying drawings.

FIG. 1 illustrates a schematic diagram of an incremental update process;

FIG. 2 schematically illustrates the setup of storage partitions of an embedded device in a firmware update method for an embedded device provided in the present application;

FIG. 3 schematically illustrates a flowchart of a specific implementation of the firmware update method for an embedded device provided in the present application;

FIG. 4 schematically illustrates a schematic diagram of generating difference data and extra data in original differential coding data;

FIG. 5 schematically illustrates a specific representation of the original differential coding data;

FIG. 6 schematically illustrates a schematic diagram of generating updated firmware data based on old firmware data and the original differential coding data;

FIG. 7 schematically illustrates a process flow chart of generating patch data on a development end device;

FIG. 8 schematically illustrates a process flow chart of performing incremental firmware update on the embedded device;

FIG. 9 schematically illustrates a flow chart of another specific implementation of the firmware update method for an embedded device provided in the present application;

FIG. 10 schematically illustrates a schematic diagram of a process of using an applied memory by the method provided in the present application;

FIG. 11 schematically illustrates a schematic diagram of a decoding process in another specific implementation of the firmware update method for an embedded device provided in the present application;

FIG. 12 schematically illustrates a structural block diagram of an embedded device provided in the present application;

FIG. 13 schematically illustrates a flow chart of a further specific implementation of the firmware update method for an embedded device provided in the present application;

FIG. 14 schematically illustrates a structural block diagram of a development end device provided in the present application;

FIG. 15 schematically illustrates a structural block diagram of a firmware update system for an embedded device provided in the present application.

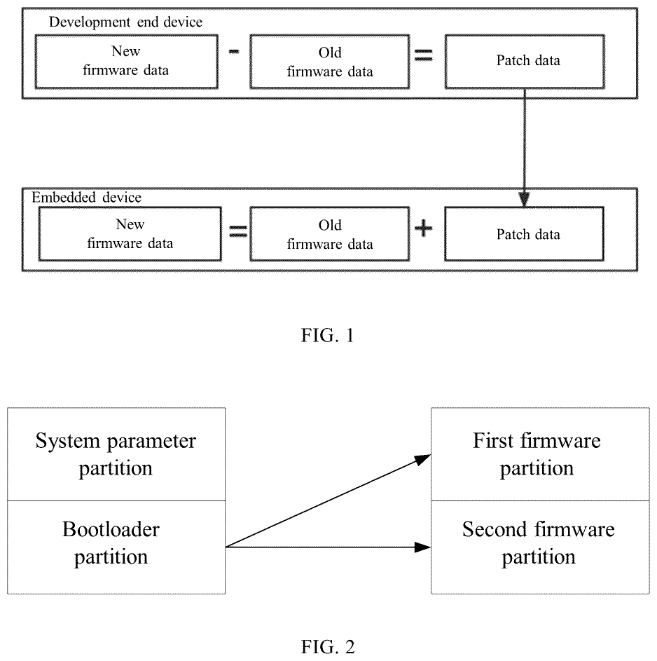

### DETAILED DESCRIPTION OF THE PREFERRED EMBODIMENTS

The method, device and system of the present application will be described in detail below in combination with the accompanying drawings and specific implementations. It is to be appreciated that the embodiments shown in the accompanying drawings and described below are merely illustrative and not intended to limit the present application.

FIG. 2 illustrates the setup of storage partitions of an embedded device in a firmware update method for an embedded device provided in the present application. Referring to FIG. 2, a storage region of the embedded device is provided with a first firmware partition, a second firmware partition, a bootloader partition, and a system parameter partition.

The bootloader partition is configured to store a bootloader program which is configured to perform the functions of detecting system parameters, verifying firmware, and determining which firmware to load and run.

The system parameter partition is configured to store system configuration, network connection information, system boot parameters and other information. It is appreciated that the system parameter partition may be divided into a plurality of partitions for management in an actual device, which is not defined here.

The first firmware partition is configured to store a first firmware, and the second firmware partition is configured to store a second firmware. It is appreciated that each firmware may implement the function of firmware update method for an embedded device provided in the present application.

The implementation process of firmware update for an embedded device through the first firmware is specifically as follows: when the embedded device runs the first firmware, it restores updated firmware data in batches by acquiring patch data from a source device and combining it with the firmware data in the first firmware, and writes the updated firmware data into the second firmware partition. System parameters are modified, and the second firmware is set as a to-be-booted partition. The system reboots, after which the bootloader program loads and runs the updated firmware data in the second firmware partition according to the system parameters.

The implementation process of firmware update for an embedded device through the second firmware is specifically as follows: when the embedded device runs the second firmware, it restores updated firmware data in batches by acquiring patch data from the source device and combining it with the firmware data in the second firmware, and writes the updated firmware data into the first firmware partition. System parameters are modified, and the first firmware is set as a to-be-booted partition. The system reboots, after which the bootloader program loads and runs the updated firmware data in the first firmware partition according to the system parameters.

By adopting the above method, a “ping-pong upgrade” of the embedded device may be implemented, such that the function of incremental update of the embedded device may be stably performed.

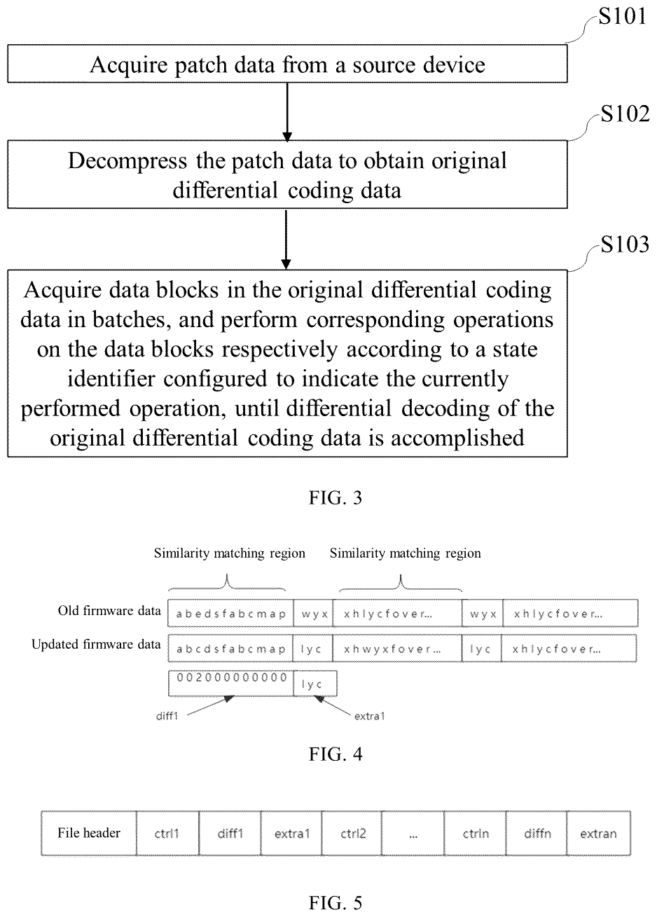

FIG. 3 illustrates a flowchart of a specific implementation of the firmware update method for an embedded device provided in the present application; As shown in FIG. 3, the method is applied to an embedded device and specifically includes the following steps:
Step S101: acquire patch data from a source device, the patch data is data obtained by compressing original differential coding data;

When performing a firmware update, the embedded device may acquire patch data from a source device. It should be appreciated that the “source device” herein refers to any computing device that provides patch data to an embedded device of which firmware is to be upgraded. For example, the source device may be a cloud server, a local server, a node of a mesh network, or a device in a Bluetooth Low Energy (BLE) network. It should be appreciated that the source device may be located in the cloud or locally. The source device and the embedded device may communicate with each other by means of Wi-Fi, Bluetooth, ZigBee, Ethernet, etc. The specific implementation is compatible with various communication methods and is not defined here.

Patch data may be generated by compressing the original differential coding data by a development end device and saved on the development end device, or the patch data may be sent to the source device. That is, the embedded device of which firmware is to be upgraded may acquire patch data directly from the development end device, or may acquire patch data from other devices storing patch data, which does not affect the implementation of the present application.

It is appreciated that patch file is complete data obtained by compressing the original differential coding data. The patch data is a part of data in the patch file. The embedded device in the present application does not need to directly acquire the complete patch file during the firmware update, avoiding excessive storage pressure on the device caused by the large amount of data that needs to be temporarily stored when acquiring the patch file. In the present application, by acquiring patch data, the acquired data may be processed in batches in a timely manner.
Step S102: decompress the patch data to obtain original differential coding data.

Decompress the patch data to obtain the original differential coding data. The original differential coding data is data obtained after performing differential processing and encoding on old firmware data and updated firmware data, and the original differential coding data includes a plurality of data blocks, each of which includes control data, difference data and extra data.

Specifically, by determining similarity matching regions of the old firmware data and the updated firmware data, and the data in the similarity matching regions may be subjected to differential processing and encoded as difference data (diff data). Encoding the data between two similarity matching regions as extra data (extra data). As shown in FIG. 4, diff 1 data, extra 1 data are the original differential coding data corresponding to the first similarity matching region.

Control data (ctrl data) is generated based on the above difference data and extra data. The ctrl data may be in a ternary array (x, y, z), where x represents the number of bytes of diff data, y represents the number of bytes of extra data, and records the offset address of the original data corresponding to the diff data in the old firmware data.

The generated control data, the difference data, and the extra data are written into a data block, and a plurality of the data block are arranged to generate the original differential coding data for firmware update of the embedded device.

As a specific implementation, the generated control data, difference data, and extra data may be written into the data block in sequence, and the operation is repeated by continuously writing ctrlᵢ, diffᵢ, extraᵢ (i=0, 1, 2 . . . ) until the entire update firmware is processed. A specific representation of the original differential coding data is shown in FIG. 5.
Step S103: acquire data blocks in the original differential coding data in batches, and perform corresponding operations on the data blocks respectively according to a state identifier configured to indicate the currently performed operation, until differential decoding of the original differential coding data is accomplished.

Data blocks in the original differential coding data are acquired in batches, and corresponding operations on the acquired data blocks are performed according to the state identifier. For the data blocks in the original differential coding data, the operation of downloading, decompressing and decoding may be performed simultaneously. For example, 30 bytes of data are acquired from the source device, and the 30 bytes of data may be decompressed. If 60 bytes of original differential data are obtained after decompression, the differential decoding is performed using the 60 bytes of original differential data.

The performing corresponding operations on the data blocks respectively according to a state identifier configured to indicate the currently performed operation may specifically include:
in response to that the state identifier is a first identifier indicating the performing of an operation to read the control data, reading the control data;
in response to that the state identifier is a second identifier indicating the performing of an operation to add the difference data, reading, according to the control data, the difference data into a pre-allocated buffer in batches to perform an addition operation, wherein a length of the data for a single addition operation does not exceed a preset buffer length;
in response to that the state identifier is a third identifier indicating the performing of an operation to copy the extra data, reading, according to the control data, the extra data into the buffer in batches to perform a copy operation, wherein a length of the data for a single copy operation does not exceed the preset buffer length.

The data obtained after each addition operation or copy operation is written into a storage partition of the embedded device. It is appreciated that the storage partition is the storage partition corresponding to the updated firmware. For example, when the first firmware is running, the data obtained after each addition operation or copy operation is written into the second firmware partition in real time. When the second firmware is running, the data obtained after each addition operation or copy operation is written into the first firmware partition in real time. The solution provided in the present application may consume the data currently stored in the buffer in a timely manner such that the buffer may be subsequently reused to perform operations on the data next time.

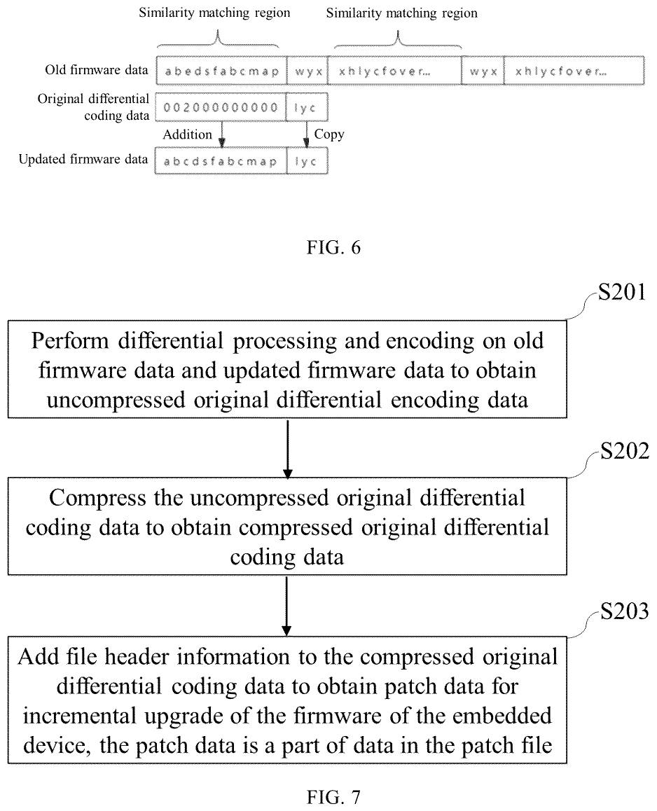

In a specific implementation, the ctrl data in the data block may be read first. Then, an addition operation is performed, specifically, the diff data is read, and the old firmware data is retrieved according to the offset address of the original data corresponding to the diff data recorded in z of the control data in the old firmware data. As shown in FIG. 6, the read old firmware data is added to the diff data to obtain updated firmware data, and the obtained updated firmware data is written into the storage partition of the embedded device. Secondly, a copy operation is performed, specifically, the extra data in the data block is copied and written into the storage partition of the embedded device. The above process is repeated until the corresponding operations are performed on all data blocks, and the updated firmware may be obtained in the storage partition of the embedded device.

The solution provided in the present application may acquire only a part of the data of the patch file during firmware updates of the embedded device, instead of directly acquiring the complete patch file, avoiding excessive storage pressure on the device caused by the large amount of data that needs to be temporarily stored to obtain the patch file. The data may be acquired in batches and the acquired data may be processed in batches in a timely manner. A state identifier is configured to indicate the currently performed operation, such that corresponding operations may be performed on the control data, difference data, and extra data in each data block respectively, and differential decoding may be performed in batches. The data obtained after differential decoding may be written into a specified storage partition in a timely manner without the need to perform operations after obtaining the complete data block, avoiding consumption of device memory caused by temporarily storing too much data in the memory, enabling the incremental update method also to be run normally on IoT devices with limited resources such as small memory.

In addition, some of the existing incremental update methods can only process the firmware corresponding to a certain embedded platform device, and require coordination with the compilation technology and firmware format of the embedded device to function normally. For example, the courgette algorithm and the exediff algorithm are used to update applications on the Google Chrome and Windows platform, respectively. The method provided in the present application is independent of the architecture and compiler of the embedded device and thus may support cross-platform use.

In addition, in the existing differential upgrade solutions, some solutions store the original differential coding data (including memory or physical storage space), which requires additional physical storage space; some solutions need to save the entire received original differential coding data in memory to run the incremental update algorithm, but when the original differential coding data is too large, the memory space required will be very large, making it impossible to update, or the large changes involved in this update need to be divided into several small changes and the incremental update must be performed several times to accomplish the final update, resulting in update failure or low efficiency, and the need to expand physical storage space (such as RAM), as well as high equipment costs. The solution adopted in the present application performs the differential decoding in a timely manner by recording the state identifier during the differential decoding, and the differentially decoded data may be written in real time into the specified storage partition, thereby avoiding temporarily storing too much data in the memory. Compared with existing incremental update solutions, this solution does not require additional patch data storage space in the physical storage space.

It is appreciated that patch data may be generated in a development end device with abundant computing and memory resources. The generated patch data may be stored in the development end device, that is, the development end device itself may serve as a source device. Alternatively, the generated patch data may also be sent to other source devices for storage, such as a cloud device. The embedded device may communicate with the source device to obtain patch data.

In addition, in the embodiments of the present application, file header information may be added to the compressed original differential coding data, as shown in FIG. 5, file header information is added before a plurality of data blocks.

As shown in FIG. 7, the process of generating patch data on a development end device may specifically include:
Step S201: perform differential processing and encoding on old firmware data and updated firmware data to obtain uncompressed original differential encoding data;
Step S202: compress the uncompressed original differential coding data to obtain compressed original differential coding data;
Step S203: add file header information to the compressed original differential coding data to obtain patch data for incremental upgrade of the firmware of the embedded device, the patch data is a part of data in the patch file. After the patch data is generated, an operation of packing the patch data to generate a patch file may also be included.

As a specific implementation, the file header information may include a decompression algorithm to be used by the embedded device, a decompression level, verification information for verification, and a preset buffer length. Of course, other information may also be included, without limitations here.

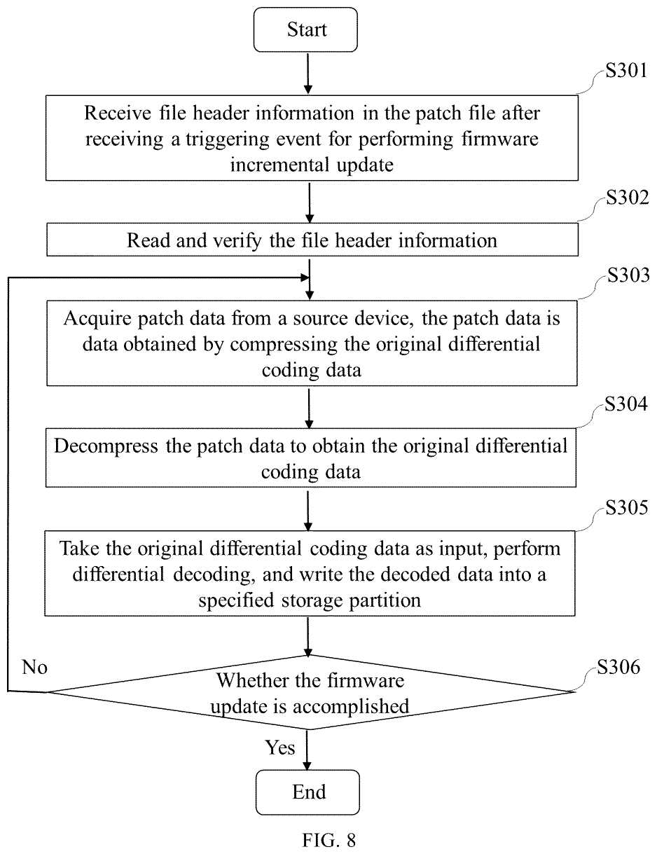

After receiving the patch data sent by the source device, the embedded device decompresses the patch data to obtain original differential coding data, and then performs the operation of differential decoding corresponding to the differential coding. In addition, on the basis that the original differential coding data includes file header information, correspondingly, the embedded device may optionally include an operation of parsing the file header information, and may further include an operation of verifying the file header information. As shown in FIG. 8, the process of performing incremental firmware update on an embedded device may specifically include:
Step S301: receive file header information in the patch file after receiving a triggering event for performing firmware incremental update;

The triggering event may be: receiving a push message sent by the source device indicating that there is an updated version of the firmware. The push information may include information such as the version number of the updated firmware, a download link of the updated firmware, and verification data. In addition, the triggering event may also be: sending a query request to the source device as to whether there is an updated version of the firmware, and receiving a reply message from the source device indicating that there is an updated version. The embedded device may actively send the above query request to the source device at regular intervals or at each power-up. Upon receipt of the triggering event, the subsequent steps of the firmware incremental update are initiated.
Step S302: read and verify the file header information;

By verifying the file header information, it is determined whether there are any errors in the file header information data, thereby ensuring the security of the system.
Step S303: acquire patch data from a source device, the patch data is data obtained by compressing the original differential coding data;
Step S304: decompress the patch data to obtain the original differential coding data;

The step of decompressing the patch data includes: decompressing the patch data using a decompression algorithm supporting streaming decompression. For example, any one or any combination of the xz algorithm, the lz77 algorithm, and the lzw algorithm is used.
Step S305: take the original differential coding data as input, perform differential decoding, and write the decoded data into a specified storage partition;
Step S306: determine whether the firmware update is accomplished, if not, return to S303; if yes, end.

It is appreciated that the main memory consumption during the incremental firmware update of the embedded device is the decompression process and the differential decoding process. The memory consumption of decompression may be adjusted by adjusting the compression level of the decompression algorithm or using a different compression algorithm. Table 1 below lists the decompression memory required for the decompression process corresponding to different compression levels of the common xz and lzw compression algorithms suitable for embedded platforms. After determining the memory required for the decompression process, the memory consumption of the differentiating and decoding process is the main factor affecting the memory consumption of embedded devices.

TABLE 1

| | Compression | Decompression Memory |
|---|---|---|
| Name | level | (KB) |
| xz | 8 | 32 |
| xz | 9 | 38 |
| lzw | 4 | 16 |
| lzw | 6 | 64 |

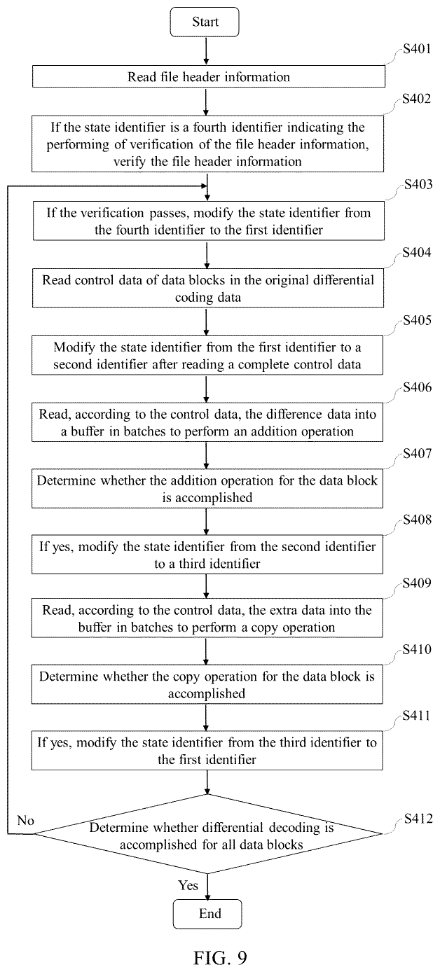

Referring to FIG. 9, a flowchart of another specific implementation of the firmware update method for an embedded device provided in the present application is provided, which describes in detail the process of performing decoding in S305 in the above embodiment, and the process may specifically include:
Step S401: read file header information;
Step S402: if the state identifier is a fourth identifier indicating the performing of verification of the file header information, verify the file header information according to the file header information;
Step S403: if the verification passes, modify the state identifier from the fourth identifier to a first identifier;
Step S404: read control data of a data block in the original differential coding data;
Step S405: modify the state identifier from the first identifier to the second identifier after reading a complete control data;
Step S406: read, according to the control data, the difference data into a buffer in batches to perform an addition operation, wherein a length of the data for a single addition operation does not exceed a preset buffer length;
Step S407: determine, based on the number of bytes of difference data in the data block indicated in the control data, whether the addition operation for the data block is accomplished;
Step S408: if yes, modify the state identifier from the second identifier to a third identifier;
Step S409: read, according to the control data, the extra data into the buffer in batches to perform a copy operation, wherein a length of the data for a single copy operation does not exceed the preset buffer length;
Step S410: determine, based on the number of bytes of extra data in the data block indicated in the control data, whether the copy operation for the data block is accomplished;
Step S411: if yes, modify the state identifier from the third identifier to the first identifier;
Step S412: determine whether differential decoding is accomplished for all data blocks of the original differential coding data; if yes, return to S404; if no, end.

The data obtained after each addition operation or copy operation is written into a storage partition of the embedded device.

It is appreciated that the buffer in the present application is a software entity that is pre-allocated from the embedded device memory and performs operations.

The buffer length may be preset. As an optional implementation, developers may determine an appropriate buffer length and make corresponding settings after performing a simulated OTA testing locally. Of course, the preset buffer length may also be dynamically adjusted according to the actual memory of the embedded device, thereby making full use of the advantages of the memory.

As a specific implementation, the buffer length to be used may be set in the file header information. The specific value of the buffer length may be obtained by reading the file header information.

After the buffer length is set, when the length of the difference data or extra data in one of the plurality of data blocks is greater than the preset buffer length, the difference data or extra data is processed in batches. Specifically, the length of the data for a single addition operation or copy operation does not exceed the preset buffer length. By adopting the method of processing in batches of the present application, even if the amount of data is large, the received data may be consumed in a timely manner by processing in batches, thereby ensuring that memory consumption is controllable.

IoT systems are usually composed of a series of devices with different hardware and software resources, and the available memory size varies among different devices. The memory consumption of existing incremental update methods is not easily evaluated and cannot be adjusted, resulting in that some incremental update algorithms cannot be run in resource-constrained IoT devices due to the large memory consumption required. While some incremental update algorithms require relatively small memory consumption, their compression performance is greatly limited. The present application, through the setting of this preset buffer length, may evaluate a specific numerical value of the memory consumption of the embedded device, and may also make dynamic adjustments accordingly based on the actual memory of the embedded device, thereby making full use of the memory resources and computing power of the device. It may be applicable to various types of devices with large differences in computing resources and memory resources, and has better compatibility.

For example, for 1000-byte original differential coding data, if the memory space available for device A is small, such as 20 KB, then a relatively resource-saving decompression algorithm may be used or the compression level of the compression algorithm may be set to a lower level, and the above preset buffer length for performing differential decoding may be set to a smaller value, assuming that the time for incremental update is 500 ms at this time. If the memory space available for device B is large, such as 50 KB, then an algorithm with stronger compression capability or higher compression level may be used to generate a smaller patch file to save more traffic and time, and the above preset buffer length for performing differential decoding may be set to a larger value. In this case, the patch data may be received within 200 ms to accomplish the firmware update. It can be seen that the method provided in the present application enables firmware updates for devices with different resources, regardless of whether the device has a small available memory or a large available memory.

It is appreciated that setting the compression rate of the compression algorithm to a higher level, or using a compression algorithm with a higher compression rate, is able to increase the compression rate, making the generated patch file smaller, thereby saving transmission time and traffic. Therefore, for an embedded device with sufficient memory, the development end device may increase the compression rate to save transmission time and traffic. Alternatively, the preset buffer length of the embedded device may be set to a larger value to reduce the decoding time. Accordingly, for a device with limited memory, the development end device may reduce the compression rate. Alternatively, the preset buffer length of the embedded device may be set to a smaller value to ensure that the firmware update can be accomplished even in the case of insufficient memory.

For example, for 1000-byte original differential coding data, Table 2 shows a comparison of the time required for receiving, decompressing and decoding by the corresponding embedded devices when the compression algorithm is LZW, with different compression levels, compression rates, decompression memories, and lengths of buffers for differential decoding.

TABLE 2

| | | | | | Time for the |
|---|---|---|---|---|---|
| | | | | Buffer for | device to |
| | | | | differential | receive + |
| Compression | Compression | Compression | Decompression | decoding | decompress + |
| algorithm | level | rate | Memory (KB) | (KB) | decode |
| lzw | 4 | 91% | 16 | 4 | 1200 ms |
| lzw | 4 | 91% | 16 | 8 | 1000 ms |
| lzw | 6 | 94% | 64 | 8 | 800 ms |

The specific process of performing differential decoding in the above embodiment is further described in detail below. In this embodiment, the implementation of differential decoding may be divided into two processes: an initialization process and a process of performing decoding.

The initialization process is the basis for subsequent decoding, mainly applying for memory space of the device. This may include the memory space required by the following objects:
(1) buffer_a: the size is a, configured to record the state identifier of the differential decoding and the file header information of the patch file. The size of the memory space required is the memory space required for the state identifier and the file header information. The state identifier is configured to indicate which step of decoding is currently being performed, and may be represented by a 1-byte global variable; the file header information may include information such as the version information of the updated firmware, verification data, the decompression algorithm to be used by the embedded device, the decompression level, and the preset buffer length, and the size of which may be customized. Taking the file header information containing 31 bytes as an example, the entire memory space required for recording the state identifier of the differential decoding is 32 bytes.
(2) buffer_b: the size is b, configured to record the ctrl data required for decoding. As described previously, the ctrl data may be in a ternary array (x, y, z), where x represents the number of bytes of diff data, y represents the number of bytes of extra data, and z records the offset address of the original data corresponding to the diff data in the old firmware data. In an 8-bit or 32-bit processor, the size of the firmware is usually not too large, and the triple array may be represented using three 4-byte variables. Larger firmware may be represented using 8-byte variables. In this embodiment, taking three 4-byte variables as an example, the size of the state identifier of the ctrl data is 24 bytes.
(3) Two buffers of size m, the first buffer (buffe_m1) and the second buffer (buffer_m2), for temporarily storing decoded data, that is, the preset buffer length is m. For example, if m=4 KB, the buffer space required for this part is 8 KB.

The process of determining the required memory during initialization is specifically as follows: establish a connection with the source device, and apply for a buffer_p of size p to store the received data; apply for a buffer_q of size q to store the original differential coding data obtained by decompression; apply for a buffer_a of size a to store the state identifier and the file header information, apply for a buffer_b of size b to store the ctrl data required for decoding, and apply for a buffer_m1 and a buffer_m2 of size m to store the decoded data.

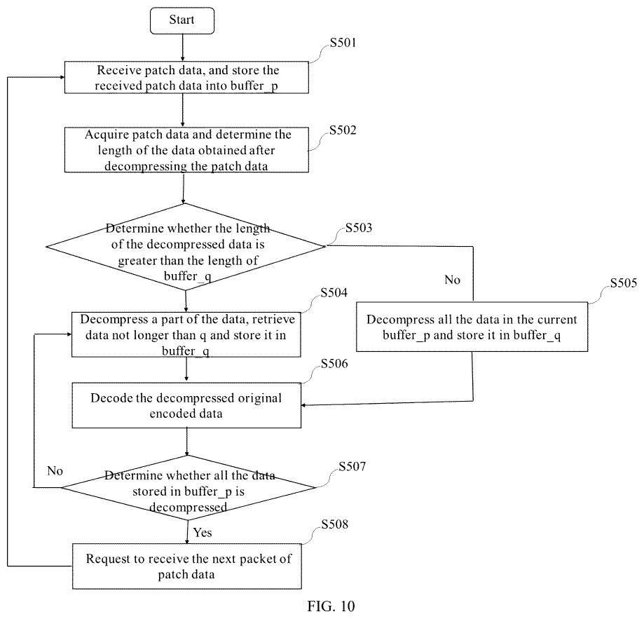

Referring to FIG. 10, a schematic diagram of a process of using the applied memory by the method provided in the present application. The process of using the applied memory above when receiving patch data is specifically as follows:
Step S501: receive patch data, and store the received patch data into buffer_p;
Step S502: acquire patch data and determine the length of the data obtained after decompressing the patch data;
Step S503: determine whether the length of the decompressed data is greater than the length of buffer_q; if yes, proceed to S504; if no, proceed to S505;
Step S504: decompress a part of the data, retrieve data not longer than q and store it in buffer_q, and proceed to S506;
Step S505: decompress all the data in the current buffer_p, store it in buffer_q, and proceed to S506;
Step S506: decode the decompressed original encoded data;
Step S507: determine whether all the data stored in buffer_p is decompressed; if yes, proceed to S508; if no, return to S504;
Step S508: request to receive the next packet of patch data, and return to S501.

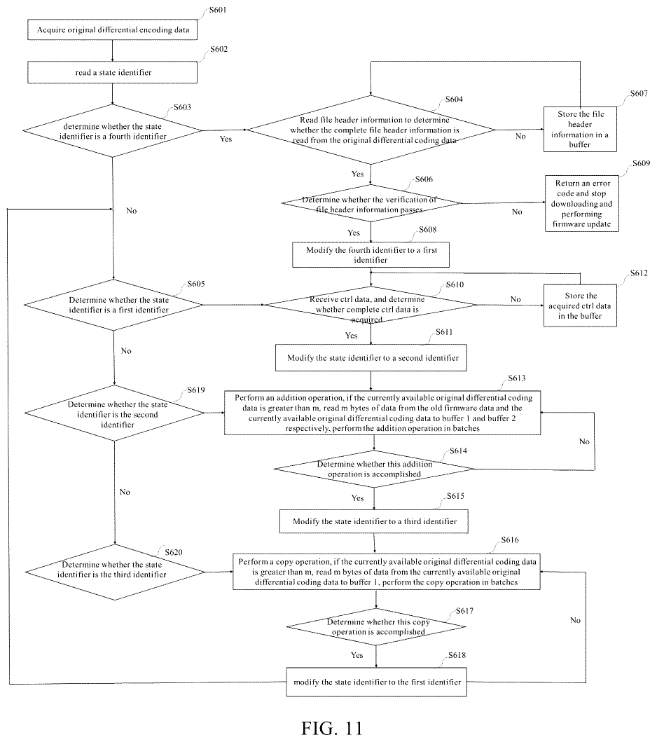

Referring to FIG. 11, the decoding process specifically includes the following steps:
Step S601: acquire original differential encoding data and proceed to S602;
Step S602: read a state identifier and proceed to S603;

In this embodiment, different digital identifiers may be used to indicate different state identifiers. For example, the first identifier may be represented by the number “1”, and is configured to indicate that the stage currently being performed is the stage of reading control data. The second identifier may be represented by the number “2”, and is configured to indicate that the stage currently being performed is the stage of adding difference data. The third identifier may be represented by the number “3”, and is configured to indicate that the stage currently being performed is the stage of copying extra data. The fourth identifier may be represented by the number “0”, and is configured to indicate the performing of verification of file header information. It is appreciated that the state identifier may also adopt other identification methods, without limitations here.

As a specific implementation, the state identifier is indicated by a state machine provided.
Step S603: determine whether the state identifier is a fourth identifier; if yes, proceed to S604; if no, proceed to S605;
Step S604: read file header information to determine whether the complete file header information is read from the original differential coding data; if yes, proceed to S606; if no, proceed to S607;

Specifically, the file header information is read from the original differential coding data. If the complete file header information is read, the file header information verification is performed. Otherwise, temporarily store the acquired data and wait to receive more data until the file header information is completely acquired.
Step S605: determine whether the state identifier is a first identifier; if yes, proceed to S610; if no, proceed to S619;
Step S606: determine whether the verification of file header information passes; if yes, proceed to S608; if no, proceed to S609;
Step S607: store the file header information in a buffer and return to S604;
Step S608: modify the fourth identifier to a first identifier, and proceed to S610;

Specifically, after the verification of file header information passes, modify the state identifier from “0” to “1” and proceed to the subsequent step of reading ctrl data.
Step S609: return an error code and stop downloading and performing firmware update.
Step S610: receive ctrl data, and determine whether complete ctrl data is acquired for the currently processed data block; if yes, proceed to S611; if no, proceed to S612.
Step S611: modify the state identifier to a second identifier, and proceed to S613.

Specifically, when reading the complete ctrl data, modify the state identifier from “1” to “2”, and proceed to the subsequent step of performing an addition operation on the difference data. Otherwise, temporarily store the acquired data and wait for receiving more data until the complete ctrl data is acquired.
Step S612: store the acquired ctrl data in the buffer, and return to S610;
Step S613: perform an addition operation. If the currently available original differential coding data is greater than m, read m bytes of data from the old firmware data and the currently available original differential coding data to buffer 1 and buffer 2 respectively, perform the addition operation in batches, and proceed to S614;

If the currently available original differential coding data is greater than m, read m bytes of data from the old firmware data and the currently available original differential coding data to buffer 1 and buffer 2 respectively, and perform the addition operation in batches. Otherwise, perform the addition operation directly and write the obtained data into a specified storage partition.
Step S614: determine whether this addition operation is accomplished; if yes, proceed to S615; if no, return to S613;
Step S615: modify the state identifier to a third identifier, and proceed to S616;

Specifically, determine whether this addition operation is accomplished according to the size of x in the ctrl data. If the performing is accomplished, modify the state identifier from “2” to “3”, and proceed to the subsequent step of copying the extra data. Otherwise, return and wait to receive more data until this addition operation is accomplished.
Step S616: perform a copy operation. If the currently available original differential coding data is greater than m, read m bytes of data from the currently available original differential coding data to buffer 1, perform the copy operation in batches, and proceed to S617;

If the currently available original differential coding data is greater than m, then read m bytes of data from the currently available original differential coding data to buffer 1, perform the copy operation in batches, and write the data written into buffer 1 into a specified storage partition.
Step S617: determine whether this copy operation is accomplished; if yes, proceed to S618; if no, return to S616;
Step S618: modify the state identifier to the first identifier, and return to S605;

Specifically, determine whether this copy operation is accomplished according to the size of y in the ctrl data. If yes, modify the state identifier from “3” to “1” and read the ctrl data of the next data block. Otherwise, return and wait to receive more data until the copy operation is accomplished.
Step S619: determine whether the state identifier is the second identifier, if yes, proceed to S613; if no, proceed to S620;
Step S620: determine whether the state identifier is the third identifier; if yes, proceed to S616.

The method provided in the embodiments of the present application may write the data obtained by the addition operation and the copy operation into a storage partition of the embedded device in a timely manner. The storage partition may be a specified non-volatile storage device such as Flash, thereby avoiding the consumption of memory of the device caused by temporarily storing the data obtained by the addition operation and copying operation in memory. In this way, the original differential decoding data to be processed may be decoded immediately, and the memory consumption required for the entire differential decoding is only the memory consumption during initialization, that is, a+b+2m. The memory consumption of a+b is configurable and usually small. In addition, the size of m may also be configured. For example, if the size of the difference data of a certain addition operation is 8192 bytes and the size of m is 4095 bytes, then this addition operation may be performed in two times, processing 4096 bytes each time. Increasing the size of m will increase memory consumption, but may save time consumption caused by batch processing. By making the buffer adjustable, this embodiment facilitates the evaluation of memory consumption during the incremental update, and is able to take into account time consumption while fully considering memory space consumption.

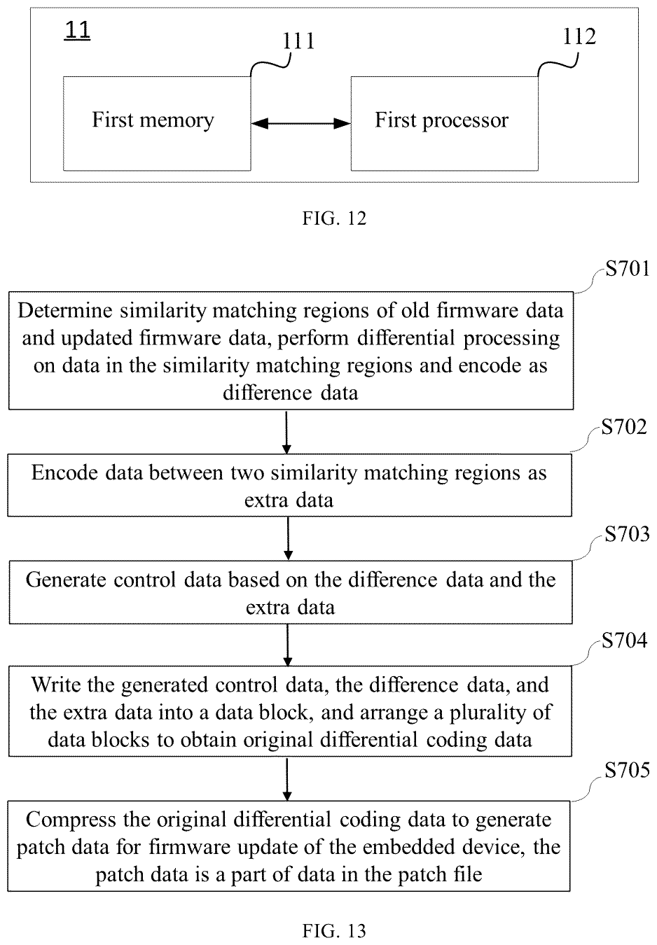

The present application further provides an embedded device 11, as shown in the structural block diagram of the embedded device provided in the present application in FIG. 12, the embedded device 11 includes: a first memory 111 and a first processor 112, the first memory 111 is configured to store a computer program, and the first processor 112 is configured to implement any of the firmware update methods for an embedded device described above when executing the computer program.

It is appreciated that the process of performing firmware update by the embedded device corresponds to the firmware update method for an embedded device described above, which may be referred to above and will not be repeated herein.

The present application further provides a firmware update method for an embedded device, as shown in FIG. 13, which is applied to a development end device and may specifically include the following steps:
Step S701: determine similarity matching regions of old firmware data and updated firmware data, perform differential processing on data in the similarity matching regions and encode as difference data.

Specifically, string matching algorithms such as hash algorithm and suffix sorting algorithm may be used to search for similarity matching regions of the old firmware data and the updated firmware data.
Step S702: encode data between two similarity matching regions as extra data;
Step S703: generate control data based on the difference data and the extra data;
Step S704: write the generated control data, the difference data, and the extra data into a data block, and arrange a plurality of data blocks to obtain original differential coding data;
Step S705: compress the original differential coding data to generate patch data for firmware update of the embedded device, the patch data is a part of data in the patch file.

After the generating patch file data for firmware update of the embedded device, the method further includes: packing the patch data to generate a patch file; sending the patch file to a source device for storage, such that the embedded device acquire the patch data in the patch file from the source device. The patch file further includes file header information, and the file header information includes a decompression algorithm to be used by the embedded device, a decompression level, verification information for verification, and a preset buffer length.

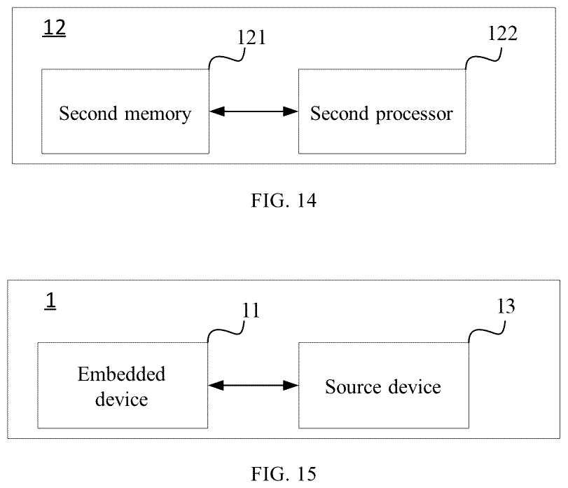

The present application further provides a development end device 12, as shown in the structural block diagram of the development end device provided in the present application in FIG. 14, the development end device 12 includes: a second memory 121 and a second processor 122, the second memory 121 is configured to store a computer program, and the second processor 122 is configured to implement any of the firmware update methods for an embedded device described above when executing the computer program.

It is appreciated that the development end device may correspond to the firmware update method for an embedded device described above, which may be referred to above and will not be repeated herein.

The present application further provides a firmware update system for an embedded device 1, as shown in the structural block diagram of the firmware update system for an embedded device provided in the present application in FIG. 15, including the embedded device 11 and a source device 13 described above.

The source device stores a patch file for firmware update of the embedded device, the patch data is a part of data in the patch file, and the patch data is data obtained by compressing the original differential coding data. The data transmission between the embedded device 11 and the source device 13 may be performed via a variety of communication protocols. The source device 13 may be a development end device, or a cloud device, or other devices in the network where the embedded device 11 is located. The embedded device 11 may adopt the firmware update method for an embedded device recorded in the present application for firmware update. The specific implementations may be referred to the description of the method content and will not be repeated herein.

Although various embodiments of various aspects of the present application have been described for the purpose of this disclosure, it shall not be appreciated that the teaching of this disclosure is limited to these embodiments. The features disclosed in a specific embodiment are not limited to that embodiment, but may be combined with the features disclosed in different embodiments. For example, one or more features and/or operations of the method according to the present application described in one embodiment may also be applied alone, in combination or as a whole in another embodiment. Those skilled in the art will understand that there are more possible optional implementations and variants, and various changes and modifications may be made to the above systems without departing from the scope defined by the claims of the present application.

1. A firmware update method for an embedded device, the method being applied to the embedded device and comprising:
acquiring patch data from a source device, the patch data being data obtained by compressing original differential coding data, and the patch data being a part of data in a patch file;
decompressing the patch data to obtain the original differential coding data, the original differential coding data being data obtained after performing differential processing and encoding on old firmware data and updated firmware data, and the original differential coding data comprising a plurality of data blocks, wherein each of the plurality of data blocks comprises control data, difference data, and extra data;
acquiring data blocks in the original differential coding data in batches, and performing corresponding operations on the data blocks respectively according to a state identifier configured to indicate the currently performed operation, until differential decoding of the original differential coding data is accomplished.

2. The firmware update method for an embedded device according to claim 1, wherein the performing corresponding operations on the data blocks respectively according to a state identifier configured to indicate the currently performed operation comprises:
in response to that the state identifier is a first identifier indicating the performing of an operation to read the control data, reading the control data;
in response to that the state identifier is a second identifier indicating the performing of an operation to add the difference data, reading, according to the control data, the difference data into a pre-allocated buffer in batches to perform an addition operation, wherein a length of data for a single addition operation does not exceed a preset buffer length;
in response to that the state identifier is a third identifier indicating the performing of an operation to copy the extra data, reading, according to the control data, the extra data into the buffer in batches to perform a copy operation, wherein a length of data for a single copy operation does not exceed the preset buffer length;
data obtained after performing the addition operation or the copy operation is written into a storage partition of the embedded device.

3. The firmware update method for an embedded device according to claim 2, wherein the patch file further comprises file header information, and after the acquiring patch data from a source device, the method further comprises:
reading the file header information from the patch file;
in response to that the state identifier is a fourth identifier indicating the performing of verification of the file header information, verifying the file header information according to the file header information;
in response to that the verification passes, modifying the state identifier from the fourth identifier to the first identifier.

4. The firmware update method for an embedded device according to claim 2, wherein after the reading the control data, the method further comprises:
modifying the state identifier from the first identifier to the second identifier after reading a complete control data.

5. The firmware update method for an embedded device according to claim 2, wherein after the reading, according to the control data, the difference data into a pre-allocated buffer in batches to perform an addition operation, the method further comprises:
determining, based on the number of bytes of difference data in the data block indicated in the control data, whether the addition operation for the data block is accomplished;
if yes, modifying the state identifier from the second identifier to the third identifier.

6. The firmware update method for an embedded device according to claim 2, wherein after the reading, according to the control data, the extra data into the buffer in batches to perform a copy operation, the method further comprises:
determining, based on the number of bytes of extra data in the data block indicated in the control data, whether the copy operation for the data block is accomplished,
if yes, modifying the state identifier from the third identifier to the first identifier.

7. The firmware update method for an embedded device according to claim 2, wherein the preset buffer length is adjustable according to the actual memory of the embedded device.

8. The firmware update method for an embedded device according to claim 7, wherein the preset buffer length is stored in file header information of the patch file.

9. The firmware update method for an embedded device according to claim 1, wherein the state identifier is indicated by a state machine provided.

10. The firmware update method for an embedded device according to claim 1, wherein the decompressing the patch data comprises:
decompressing the patch data using a decompression algorithm supporting streaming decompression.

11. An embedded device comprising a first memory and a first processor, wherein the first memory is configured to store a computer program, and the first processor, when executing the computer program, is configured to implement steps of:
acquiring patch data from a source device, the patch data being data obtained by compressing original differential coding data, and the patch data being a part of data in a patch file;
decompressing the patch data to obtain the original differential coding data, the original differential coding data being data obtained after performing differential processing and encoding on old firmware data and updated firmware data, and the original differential coding data comprising a plurality of data blocks, wherein each of the plurality of data blocks comprises control data, difference data, and extra data;
acquiring data blocks in the original differential coding data in batches, and performing corresponding operations on the data blocks respectively according to a state identifier configured to indicate the currently performed operation, until differential decoding of the original differential coding data is accomplished.

12. A firmware update method for an embedded device, the method being applied to a development end device and comprising:
determining similarity matching regions of old firmware data and updated firmware data, performing differential processing on data in the similarity matching regions and encoding as difference data;
encoding data between two similarity matching regions as extra data;
generating control data based on the difference data and the extra data;
writing the generated control data, the difference data, and the extra data into a data block, and arranging a plurality of data blocks to obtain original differential coding data;
compressing the original differential coding data to generate patch data for firmware update of the embedded device, the patch data being a part of data in the patch file.

13. The firmware update method for an embedded device according to claim 12, wherein after the generating patch data for firmware update of the embedded device, the method further comprises:
packing the patch data to generate a patch file;
sending the patch file to a source device for storage, for the embedded device to acquire the patch data in the patch file from the source device.

14. The firmware update method for an embedded device according to claim 12, wherein the patch file further comprises file header information, the file header information comprising a decompression algorithm to be used by the embedded device, a decompression level, verification information for verification, and a preset buffer length.

15. (canceled)

16. (canceled)

17. (canceled)
